(19) United States
(12) Patent Application Publication
(10) Pub. No.: US 2016/0175785 A1
(43) Pub. Date: Jun. 23, 2016

(54) An Electrical Appliance for Processing a Beverage

(71) Applicant: Top Electric Appliances Industrial LTD, Guangzhou (CN)

(72) Inventors: Weizhong Li, Guangzhou (CN); Yewu Zhong, Guangzhou (CN)

(73) Assignee: Top Electric Appliances Industrial LTD, Guangzhou (CN)

(21) Appl. No.: 14/235,118

(22) PCT Filed: Jun. 27, 2013
(86) PCT No.: PCT/CN2013/078097

§ 371 Date: Jan. 27, 2014

(30) Foreign Application Priority Data
Jun. 25, 2013 (CN) 201310252357.4

(51) Int. Cl. B01F 5/04; B01F 3/04

(52) U.S. Cl. CPC B01F 5/0413; B01F 3/04439

(57) ABSTRACT

Provided is an apparatus for automatically breathing a beverage such as red wine by passing oxygen into the beverage for a set period of time. The apparatus has an air processing system which takes in atmospheric air and processes it to concentrate its oxygen content to as much as or even higher than 90% oxygen by volume. The apparatus comprises a controller for automatically controlling parameters of the oxygen breathing process including a time period for delivery of oxygen concentrated air to a beverage where the time period is predetermined in accordance with one or more characteristics or qualities of the beverage.

### FIELD OF THE INVENTION

The invention relates to an electrical appliance for processing a beverage to improve its readiness for drinking and particularly, but not exclusively, to processing an alcoholic beverage such as red wine.

### BACKGROUND OF THE INVENTION

Some wines need to be allowed to breathe for a period of time prior to drinking to reduce or remove any malodorous vapours, to improve the smoothness of the taste of the wine, and to improve the bouquet of the wine. The process of allowing a wine to breathe normally comprises allowing the wine to be exposed to air for a period of time. Oxygen in the air acts on the wine to aerate it thereby releasing aromas and flavours in the wine.

Breathing of wine normally concerns red wines, although some white wines also benefit from this process. The degree to which a wine should be allowed to breathe, if at all, varies according to many factors including the type of wine, the age of the wine, the type of grapes used to make the wine, the temperature of the wine, the ambient temperature, quantity of wine, etc. In effect, those wines that do benefit from breathing each have a unique set of requirements for breathing to successfully improve the taste of the wine prior to drinking.

One method of allowing a wine to breathe is to simply uncork or open the bottle of wine and leave it to rest. However, the narrow neck of the wine bottle restricts airflow to the degree that this is not regarded as an efficient way to allow a wine to breathe as the period required to achieve any result may be excessive.

A more traditional way of enabling a wine to breathe is to decant the wine into a jug or wine decanter. A wine decanter has a broad open neck which allows air to flow relatively unrestricted over the surface of the wine, but even this process has its disadvantages. One is that, for some wines, it may take more than an hour or more for the aeration process to be completed with the open decanter of wine being exposed to pests such as insects during this period.

To overcome some of the disadvantages associated with the traditional use of a wine decanter, a number of devices are known which allow a user to aerate wine whilst it is being poured. Such devices often comprise a pouring funnel whereby, as wine is poured through the funnel into a glass, the wine passes over a structure in the funnel which disrupts the flow of the wine and draws air into the wine as its flow is being disrupted. A disadvantage with such devices is that they do not discriminate between different wines to take account of the different requirements for aerating required by such wines.

Furthermore, of the known devices for aerating wine including decanters, a major disadvantage is that most rely on human experience as to the degree of aeration, often measured as a period of time, but may include an assessment of ambient temperature, that any particular wine may need. However, even wines of different quality and/or vintage from the same source, e.g. vineyard, will have different breathing requirements so even connoisseurs of wine may struggle to accomplish the task successfully.

The important component in aerating a wine is exposure of the wine to oxygen, but none of the known devices increases the concentration of oxygen in the air used to aerate the wine.

Other beverages may also benefit from being aerated prior to drinking.

### OBJECTS OF THE INVENTION

An object of the invention is to mitigate or obviate to some degree one or more problems associated with known methods and devices for aerating wine.

The above object is met by the combination of features of the main claims; the sub-claims disclose further advantageous embodiments of the invention.

Another object of the invention is to improve oxygen concentration in air used to aerate beverages in improving the readiness of such beverages for drinking.

Another object of the invention is to provide a means of automatically aerating a beverage based on characteristics or parameters of the beverage.

Another object of the invention is to provide a means of automatically aerating a beverage for a user determined or automatically determined period of time based on characteristics or parameters of the beverage.

One skilled in the art will derive from the following description other objects of the invention. Therefore, the foregoing statements of object are not exhaustive and serve merely to illustrate some of the many objects of the present invention.

### SUMMARY OF THE INVENTION

The present invention provides an apparatus for automatically breathing a beverage such as red wine by passing oxygen into the beverage for a set period of time. The apparatus may comprise an electrically powered appliance. The apparatus preferably has an air processing system which takes in atmospheric air and processes it to concentrate its oxygen content to as much as or even higher than 90% oxygen by volume, although lower levels of oxygen content may suffice or be preferred for some beverages. However, in some embodiments, oxygen used to breathe the beverage may comprise atmospheric air or it may comprise a supply of pure oxygen. In the case of a supply of pure oxygen, this may comprise an already prepared source of pure or nearly pure oxygen. The apparatus preferably comprises a controller for automatically controlling parameters of the oxygen breathing process. One parameter may comprise a time period for delivery of oxygen concentrated air to a beverage where the time period is predetermined in accordance with one or more characteristics or qualities of the beverage. The set period of time may be automatically determined by the apparatus or by way of a user input to the apparatus. Other parameters may include the temperature of the beverage, the ambient temperature, the type of beverage, the quantity of the beverage, etc.

In a first main aspect, the invention provides an electrical appliance for automatically processing a beverage, said electrical appliance comprising: an inlet for drawing in atmospheric air; an air processing apparatus for concentrating oxygen in the drawn in air; and an outlet for delivering oxygen concentrated air under pressure to a beverage. The appliance may be controlled to automatically deliver oxygen to the beverage for a predetermined or user set period of time. Concentrating the amount of oxygen has the advantage of improving and considerably speeding up the aerating process. The appliance may be controlled to automatically deliver oxygen to the beverage according to any one or any combination of: percentage concentration of oxygen in the oxygen concentrated air; flow rate of oxygen concentrated air; and period of time oxygen concentrated air is being delivered to the beverage.

By oxygen concentrated air is meant air that has a percentage of volume of oxygen greater than atmospheric air, i.e. greater than 21% by volume of oxygen and preferably having a substantially greater percentage by volume of oxygen than atmospheric air, e.g. more than 30%, more than 50% or more than 70%, but preferably at least if not more than 90%.

In one embodiment, the oxygen concentrator apparatus is operated to provide oxygen concentrated air having an adjustable percentage of oxygen by volume of at least 30%.

In one embodiment, the appliance may be arranged to deliver oxygen concentrated air under pressure to a beverage contained in a receptacle. The appliance may be arranged to deliver oxygen concentrated air to a beverage such as wine contained in a bottle, glass or decanter.

In one embodiment, the appliance may be arranged to deliver oxygen concentrated air under pressure to a beverage as the beverage is being poured into a receptacle. The appliance may be arranged such that a flow of oxygen concentrated air under pressure through the outlet draws a beverage from a container for conveying said beverage to a receptacle thereby delivering oxygen concentrated air under pressure to the beverage as it is being poured. In this embodiment, the beverage, e.g. red wine, is aerated with oxygen rich air as it is being poured.

Preferably, the appliance further comprises a support plate adapted for receiving a container or receptacle. The support plate may comprise a top surface of the appliance, but preferably comprises a surface extending in front of the appliance near to the outlet. Preferably also, the appliance comprises an outlet conduit which extends to the support plate. The conduit may extend to the support plate to deliver oxygen concentrated air under pressure to a beverage contained in a container or receptacle received on the support plate.

In one embodiment, the conduit may extend over the support plate and downwardly to enter a container received on the support plate.

In one embodiment, the conduit may extend under the support plate to a support plate outlet port, the support plate outlet port being adapted to sealably engage an intake port of a container received on the support plate to thereby deliver oxygen concentrated air under pressure via said container intake port to a beverage contained in the container.

In one embodiment, the conduit may extend to the support plate to draw a beverage from a container received on the support plate and to convey the drawn beverage to a receptacle thereby delivering oxygen concentrated air under pressure to the beverage as it is being conveyed to the receptacle.

In one embodiment, the outlet may comprises a T-shaped conduit having a first downwardly extending tubular part adapted to enter a container, a second horizontally extending tubular part having a narrowed portion at a T junction between the first downwardly extending tubular part and the second horizontally extending tubular part whereby a flow of oxygen concentrated air through the narrowed portion of the second horizontally extending tubular part results in a suction force in the first downwardly extending tubular part to thereby draw up a beverage contained in the container and convey it out through an output portion of the second horizontally extending tubular part. The first downwardly extending tubular part of the outlet conduit may extendible to enable an end of said tubular part to enter into a container and extends downwardly into beverage. The first downwardly extending tubular part of the outlet conduit may be telescopically extensible or may be helically extensible.

Preferably, the air processing apparatus comprises an oxygen concentrator apparatus adapted to remove some or most gases other than oxygen from atmospheric air to thereby provide oxygen concentrated air. Preferably also, the concentrator apparatus comprises a molecular sieve adapted to remove nitrogen from atmospheric air to thereby provide oxygen concentrated air. The molecular sieve may use a zeolite material to remove nitrogen from atmospheric air and may comprise two zeolite containing vessels adapted to operate on a pressure swing adsorption process to provide oxygen concentrated air. The oxygen concentrator apparatus may be operated to provide oxygen concentrated air having at least 30% by volume, at least 50% by volume of oxygen or at least 70% by volume of oxygen or preferably at least 90% by volume of oxygen.

In one embodiment, the appliance may be controlled to vent initially processed air to atmosphere before then delivering oxygen concentrated air under pressure to a beverage. The appliance may be controlled to vent initially processed air to atmosphere until it is detected that the oxygen concentration in the processed air has reached a predetermined minimum threshold level after which said processed air comprising oxygen concentrated air is conveyed to the appliance outlet, or to vent initially processed air to atmosphere for a set period of time to enable the oxygen concentration in the processed air to reach a predetermined minimum threshold level after which said processed air comprising oxygen concentrated air is conveyed to the appliance outlet.

Preferably, the appliance has a rechargeable battery power supply which enables the appliance to be used in environments such as restaurants where connecting the appliance to a mains power supply would not be convenient. Also, preferably the air processing apparatus includes a reservoir tank for storing oxygen concentrated air under pressure for subsequent use to provide at least an initial supply of oxygen concentrated air when venting low oxygen concentrated initially processed air.

In one embodiment, the appliance may have a sensor for detecting a temperature of a beverage.

In one embodiment, the appliance may have a beverage storage tank and may have a refrigeration system for chilling beverage stored in the storage tank.

In one embodiment, the appliance may have a refrigeration system and the support plate may comprise a cold plate chilled by cooled refrigerant from the refrigerator system to thereby chill a beverage contained in a container or receptacle received on the support plate.

In one embodiment, the appliance may have a beverage storage tank and a heating system for heating beverage stored in the storage tank. The support plate may comprise a hot plate heated by said heating system to thereby heat a beverage contained in a container or receptacle received on the support plate.

Preferably, the appliance has a communications module for connecting to a communications network to download data from a computer system. It may also have machine readable medium module or port such as a USB port, SD port or the like for receiving a machine readable medium.

Preferably also, the appliance has a scanning system adapted to automatically recognize characters, indicia, codes including bar codes and QR codes, or any other information carried on a beverage container or a label of a beverage container. The scanning system may comprise a camera and a module running recognition software, although any suitable scanner such as a bar code reader may be utilized.

Preferably, a computer implemented controller of the appliance is adapted to analyze information obtained from the scanning system and to control operation of the appliance in accordance with data obtained from the analyzed information. The controller may determine from data obtained from the analyzed information a suitable beverage process program and control the appliance to implement said program when processing a beverage from which the analyzed information was obtained. A beverage process program may include any one of any combination of the control parameters: a length of time for delivery of oxygen concentrated air to said beverage; an oxygen concentration level of said oxygen concentrated air; and a flow rate for said oxygen concentrated air. The controller may retrieve a suitable beverage process program from memory or from a database. The database may comprise a networked database. The appliance may have a control panel including user input means to enable a user to adjust any of the control parameters of a beverage process program.

The appliance of the invention is particularly adapted for processing red wine, but it may be adapted to aerate other types of alcoholic and non-alcoholic beverages.

In a second main aspect, the invention provides a method of processing a beverage comprising the step of: automatically passing oxygen concentrated air under pressure through the beverage for a predetermined period of time. The method may be performed in an electrical appliance having an inlet for drawing in atmospheric air, an air processing apparatus for concentrating oxygen in the drawn in air, and an outlet for delivering oxygen concentrated air under pressure to a beverage.

In a third main aspect, the invention provides an apparatus for processing a beverage, said apparatus comprising: an electrical appliance according to the first main aspect of the invention; and a container or receptacle adapted to be received on the support plate of the appliance.

In a fourth main aspect, the invention provides an electrical appliance comprising: an outlet for delivering oxygen under pressure to a beverage; a controller for automatically controlling the delivery of oxygen to said beverage; and a communications module for connecting to a communications network to download data from a computer system. The communications module may be adapted to connect to a network to download data comprising processing characteristics of new beverages to enable the controller to automatically control the delivery of oxygen to such new beverages.

In a fifth main aspect, the invention provides an electrical appliance comprising: an outlet for delivering oxygen under pressure to a beverage; a controller for automatically controlling the delivery of oxygen to said beverage; and a scanning system adapted to automatically recognize characters, indicia, codes including bar codes and QR codes, or any other information carried on a beverage container or a label of a beverage container. The scanning system may comprise a camera and a module running recognition software.

In a sixth main aspect, the invention provides an electrical appliance comprising: an outlet for delivering oxygen under pressure to a beverage; a controller for automatically controlling the delivery of oxygen to said beverage; and a temperature sensing means for sensing a temperature of the beverage being processed.

In a seventh main aspect, the invention provides a computer program product comprising machine readable instructions which, when executed by a controller of a an electrical appliance according to any of the first, fourth, fifth or sixth main aspects of the invention, implements the steps of the method of the second main aspect of the invention.

In any of the main aspects of the invention and, in particular, the fourth to sixth main aspects, the oxygen may comprise unprocessed atmospheric air, already prepared pure or near pure oxygen gas, or oxygen concentrated air obtained from atmospheric air by the appliance.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a schematic block diagram of an electrical appliance in accordance with an embodiment of the invention;

FIG. 2 is a schematic block diagram of an appliance in accordance with the invention connected to a communications network;

FIG. 3 is a perspective view of an appliance in accordance with another embodiment of the invention;

FIG. 4 is a side sectional view of the appliance of FIG. 3;

FIG. 5 is an enlarged view of a circled section of FIG. 4;

FIG. 6 is a side sectional view of an appliance in accordance with another embodiment of the invention;

FIG. 7 is an enlarged view of a circled section of FIG. 6;

FIG. 8 is a top sectional view of the appliance of FIG. 6;

FIG. 9 is an enlarged view of a circled section of FIG. 8;

FIG. 10 is a perspective view of an appliance in accordance with another embodiment of the invention;

FIG. 11 is a side sectional view of the appliance of FIG. 10;

FIG. 12 is a top sectional view of the appliance of FIG. 10;

FIG. 13 is a side sectional view of an appliance in accordance with another embodiment of the invention;

FIG. 14 is a side sectional view of an appliance in accordance with another embodiment of the invention;

FIG. 15 is a side sectional view of an appliance in accordance with another embodiment of the invention;

FIG. 16 is a perspective view of an appliance in accordance with another embodiment of the invention;

FIG. 17 is a side sectional view of the appliance of FIG. 16;

FIG. 18 is another side sectional view of the appliance of FIG. 16;

FIG. 19 is a perspective view of an appliance in accordance with another embodiment of the invention;

FIG. 20 is a side sectional view of the appliance of FIG. 19;

FIG. 21 is another side sectional view of the appliance of FIG. 19;

FIG. 22 is an enlarged view of control circuitry for some embodiments of the invention;

FIG. 23 is a perspective view of an appliance in accordance with a preferred embodiment of the invention;

FIG. 24 is a side sectional view of the appliance of FIG. 23;

FIG. 25 is an enlarged view of a circled section of FIG. 24;

FIG. 26 is another side sectional view of the appliance of FIG. 23;

FIG. 27 is a perspective view of an appliance in accordance with another preferred embodiment of the invention;

FIG. 28 is a side sectional view of the appliance of FIG. 27;

FIG. 29 is a perspective view of an appliance in accordance with another embodiment of the invention;

FIG. 30 is a side sectional view of the appliance of FIG. 29; and

FIG. 31 is a sectional view form the back of the appliance of FIG. 29.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The present invention provides an apparatus for automatically breathing a beverage such as red wine by passing oxygen into the beverage. The apparatus preferably has an air processing system which takes in atmospheric air and processes it to concentrate its oxygen content to as much as or even higher than 90% oxygen by volume, although lower levels of oxygen concentration such as 30%, 50% or 70% may suffice or be preferred for some beverages. The oxygen concentrator apparatus may be operated to provide oxygen concentrated air having an adjustable percentage of oxygen by volume of at least 30%, but in some embodiments, it may be adjustable above at least 50%, about at least 70% or above at least 90%. The apparatus comprises a controller for automatically controlling one or more parameters of the oxygen breathing process. Parameters may include a time period for delivery of oxygen concentrated air to a beverage where the time period is predetermined in accordance with one or more characteristics or qualities of the beverage and/or in response to user inputs to the appliance. Other parameters may include a concentration level of oxygen in the processed air and a flow rate, e.g. a volume flow rate, of processed air being delivered to the beverage. It is implicit therefore that the appliance may include a sensor or the like to detect an oxygen concentration level in the processed air and a flow meter for measuring flow rates of processed air or gas.

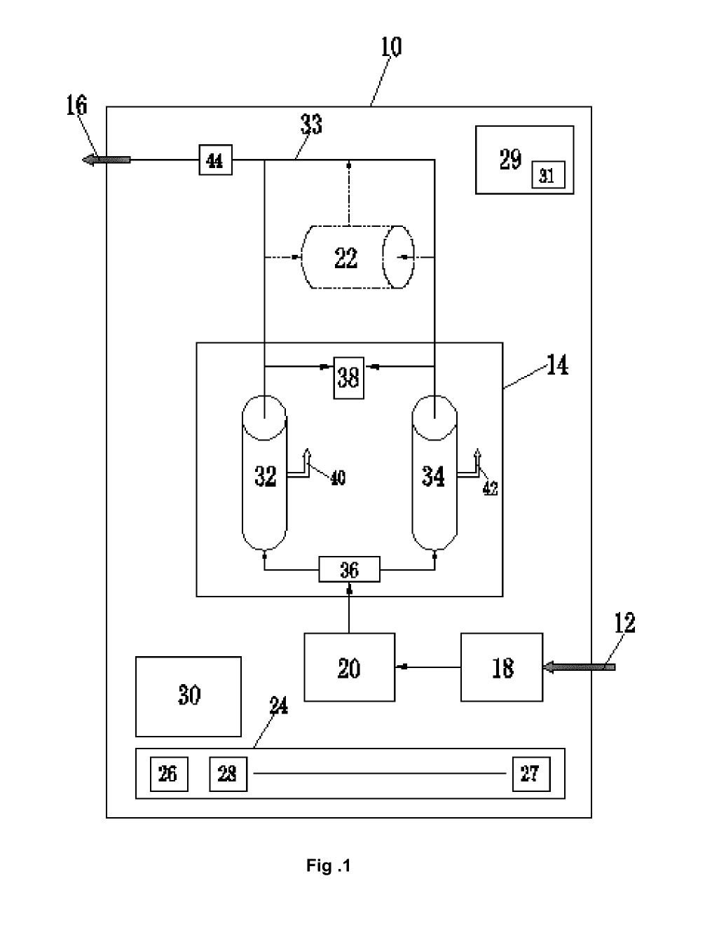

FIG. 1 shows a block schematic diagram of an electrical appliance 10 for automatically processing a beverage in accordance with the invention. The appliance 10 has an air inlet port 12 for drawing in atmospheric air to the appliance 10 and an air processing apparatus 14 for concentrating oxygen in the drawn in air. The appliance 10 includes an outlet port 16 for delivering oxygen concentrated air under pressure to a beverage being processed by the appliance 10. An air filter 18 is provided to filter drawn in atmospheric air to rid it of debris, dust and maybe even particulates before said air reaches the oxygen concentrator apparatus 14. A compressor 20 is provided to pump filtered air into the oxygen concentrator 14. Oxygen concentrated air exiting the oxygen concentrator apparatus 14 under pressure is delivered to the outlet port 16, although in some embodiments, a reservoir tank 22 (shown in broken outline in FIG. 1) may be provided as a means of temporarily storing pressurized oxygen enriched/concentrated air, or even storing processed air for longer periods of time, for subsequent use. In some embodiments, the appliance may be arranged to deliver filtered atmospheric air to a beverage in which case the oxygen concentrating apparatus may not be required.

The appliance 10 has a computer implemented controller 24. The controller 24 is adapted to control operation of all functions of the appliance 10. The controller 24 includes at least one processor 26 and at least one memory 28, but may include a number of other processors, memories and other modules 27 as required for implementing various aspects of the present invention as will be described hereinbelow.

A power supply 30 of the appliance 10 may comprise a mains power supply, but, in some embodiments, this is replaced by a rechargeable battery power supply which may be removable for recharging on an external charger module (not shown) or the battery power supply may be charged in situ. In yet further embodiments, the appliance is provided with both a mains power supply and a rechargeable battery power supply and, in this case, the controller 24 may include a charger circuit for charging the battery power supply from the mains power supply. Providing the appliance 10 with a rechargeable battery power supply enables the appliance 10 to be used in environments such as at a service point or patron's table in a restaurant where connecting the appliance 10 to a mains power supply may not be convenient.

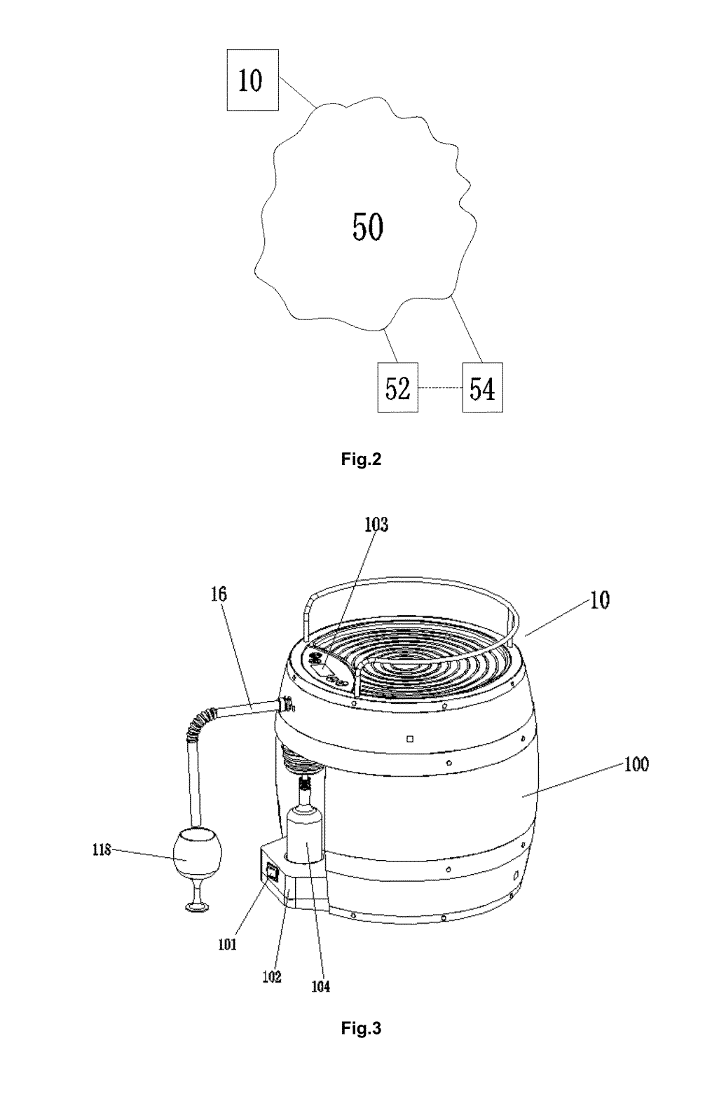

A communications module 29 may be provided as one means of enabling the appliance 10 to connect to a network (FIG. 2). The communications module preferably enables the appliance to wirelessly connect to the network, e.g. by Wi-Fi™, Bluetooth™ or the like. The appliance may be arranged to be controlled by another device such as a smart phone or tablet computer by way of remote control using a Bluetooth™ or other short range wireless communication protocol. Alternatively, or in addition, the appliance 10 may include a suitable network enabled port 31 to connect the appliance 10 by cable to a router or the like. The network enabled port 31 may be provided by the communications module 29 (as shown in FIG. 1) or by the controller 24.

The oxygen concentrator apparatus 14 may comprise any suitable molecular sieve apparatus for increasing the concentration of oxygen in atmospheric air, but preferably comprises a zeolite based oxygen concentrator apparatus 14 operating on a pressure swing adsorption process. As such, the oxygen concentrator apparatus 14 includes first and second zeolite containing vessels 32, 34. The oxygen concentrator apparatus 14 is adapted to remove some or most gases, e.g. nitrogen, other than oxygen from atmospheric air to thereby provide oxygen concentrated or oxygen enriched air.

In operation of the oxygen concentrator apparatus 14, at high pressure, nitrogen sticks to the surface of the zeolite. Because the zeolite is extremely porous, it has a very large surface area and can adsorb large volumes of gas. At low pressure the nitrogen is released. The oxygen concentrator 14 includes a swing valve 36 which acts to direct pressurized filtered air into the first and second zeolite vessels 32, 34 in turn on a half-cycle basis.

The oxygen concentration process is cyclical with each cycle having two halves of equal duration. The cycle can be explained with respect to the first vessel 32 as follows. In the first half of a cycle the first vessel 32 receives air from the compressor 20. The first half cycle lasts typically about 3 seconds, but may last longer. During that time the pressure in the first vessel 32 rises from atmospheric pressure to a few times normal atmospheric pressure (typically 20 psi/138 kPa gauge, or 2.36 atmospheres absolute) and the zeolite material becomes saturated with nitrogen so that pumping in additional air would begin to reduce the oxygen concentration. Part way through the first half of the cycle the gas in the first vessel 32 becomes close to pure oxygen, although small amounts of argon, CO₂, water vapor, radon and other minor atmospheric components remain. The swing valve 36 is opened to allow gas to start flowing to a pressure equalizing reservoir 38. At the end of the first half of the cycle there is another valve position change so that the air from the compressor 20 is directed to the second vessel 34. As oxygen concentrated air (almost pure oxygen) in the first vessel 32 flows to the reservoir 38, the pressure in the first vessel 32 drops, and the nitrogen adsorbed on its zeolite begins to be released back into the gas, so that the oxygen concentration begins to drop. Part way through the second half of the cycle there is another valve change whereby the gas still in the first vessel 32 is vented to atmosphere through a respective vent 40, 42. The swing adsorption process preferably keeps the concentration of oxygen in the pressure equalizing reservoir 38 from falling below about 90%. The pressure in the pathway 33 delivering oxygen concentrated air from the equalizing reservoir 38 to the outlet 16 is kept relatively steady by a pressure reducing valve 44.

In some embodiments, the oxygen concentrator apparatus 14 may be operated to provide oxygen concentrated air having at least 50% by volume of oxygen or at least 70% by volume of oxygen, but it is preferably operated to provide at least 90% by volume of oxygen.

In one embodiment, the appliance 10 may be controlled to vent initially processed air to atmosphere before then delivering oxygen concentrated air under pressure to a beverage via the outlet port 16. The appliance 10 may be controlled to vent initially processed air to atmosphere until it is detected that the oxygen concentration in the processed air has reached a predetermined minimum threshold level after which said processed air comprising oxygen concentrated air is conveyed to the appliance outlet port 16. An oxygen level detector may be provided in the appliance 10 for this purpose. However, it is preferred that initially processed air is vented to atmosphere for a set period of time to enable the oxygen concentration in the processed air to reach a predetermined minimum threshold level as this requires only a timing control by the controller 24 and does not require any oxygen level detection means.

Referring now to FIG. 2, shown in block schematic form is an appliance 10 in accordance with any of the embodiments of the invention where said appliance 10 is enabled to connect to a communications network 50 such as the Internet. The appliance 10 may connect wirelessly to the network 50 via the communications module 29 or by way of an electronic connection such as a cable, e.g. Ethernet cable, plugged in to the appliance's network enabled port 31. As will be explained in more detail below, the appliance may connect to a server 52 and/or database 54 via the network 50 to download data to the appliance. In some embodiments, data downloads may comprise computer program software updates for the controller 24. In the same or other embodiments, data downloads may comprise downloads of data relating to beverages in order to enable the appliance to automatically process a beverage according to characteristics or parameters of a beverage. The data downloads may update an onboard memory 28 or database of the appliance 10 comprising beverage process programs. The appliance 10 may also be enabled to upload data to the server 52 and/or database 54 and this may comprise part of a subscription service whereby the user of the appliance 10, in exchange for a fee, subscribes to a service for updates on new beverage oxygen processing parameters, etc.

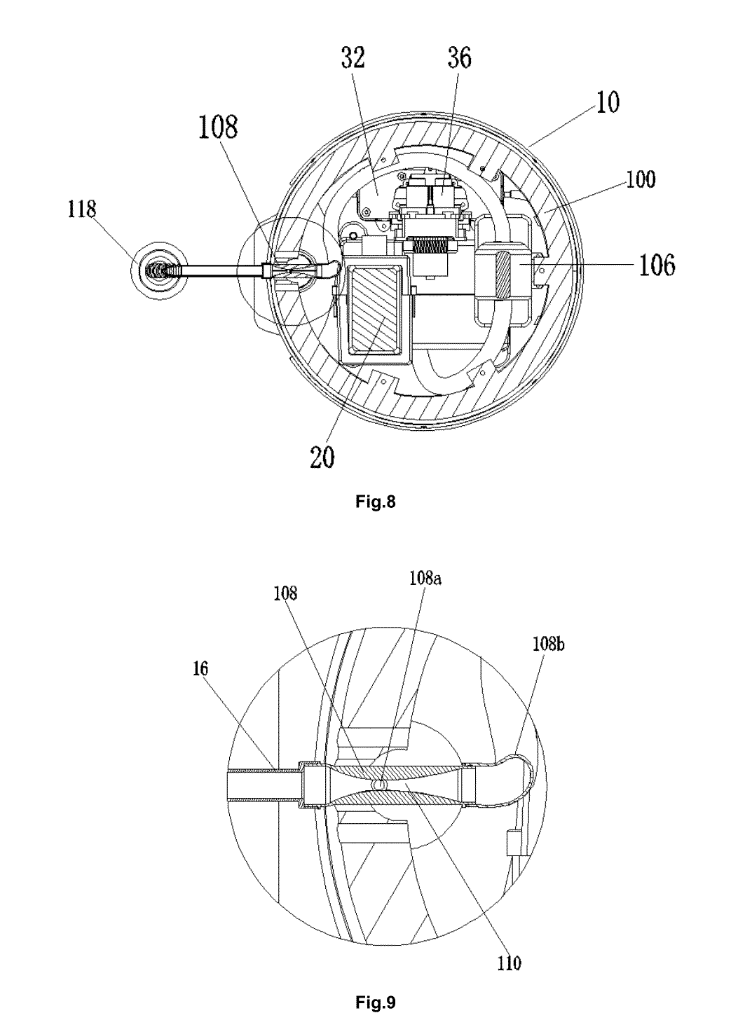

Referring now to FIGS. 3 to 9, shown is a number of embodiments of an appliance 10 in accordance with the invention. In all embodiments of FIGS. 3 to 9, the appliance 10 comprises a barrel shaped housing 100 having a support plate 102 for receiving a container such as a bottle of wine 104. A power switch 101 is provided on a front face of the support plate 102, although it could be provided elsewhere on the appliance 10. A control panel 103 is provided on a top portion of the housing 100 for receiving user inputs at the appliance 10 and/or providing information to a user. The housing 100 has an inlet port 12 and an outlet port 16. The inlet port 12 is connected to a compressor 20 which in turn is connected to an inlet of an oxygen concentrator 14 via its swing valve 36.

The oxygen concentrator 14 may include a pump 106 for further pressurizing oxygen concentrated air exiting the molecular sieve 32, 34 of a type as hereinbefore described.

The outlet port 16 of the appliance 10 which delivers oxygen to a beverage comprises a T-shaped conduit 108 (FIGS. 5, 7 & 9) having a first downwardly extending tubular part 108a adapted to enter a container, a second horizontally extending tubular part 108b having a narrowed portion 110 at a T junction between the first downwardly extending tubular part 108a and the second horizontally extending tubular part 108b. Pressurized oxygen concentrated air flowing through the narrowed portion 110 of the second horizontally extending tubular part 108b results in a Venturi effect suction force by the Bernoulli Principle in the first downwardly extending tubular part 108a which causes a beverage contained in the container 104 to be drawn up and conveyed out through an output portion 112 of the second horizontally extending tubular part 108b.

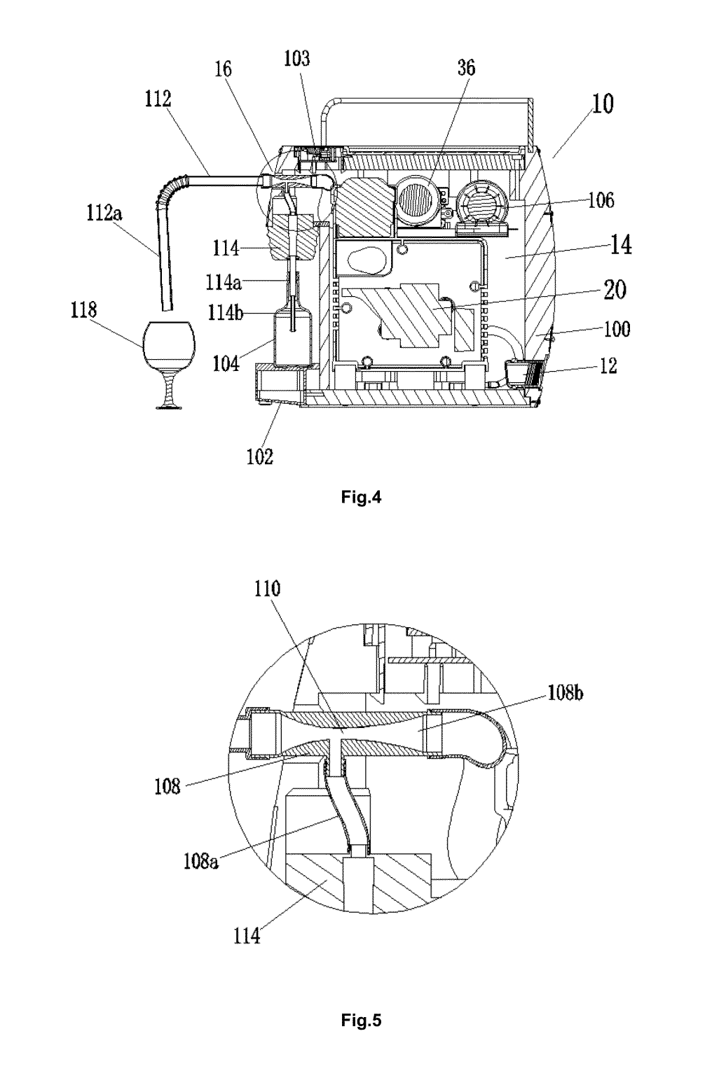

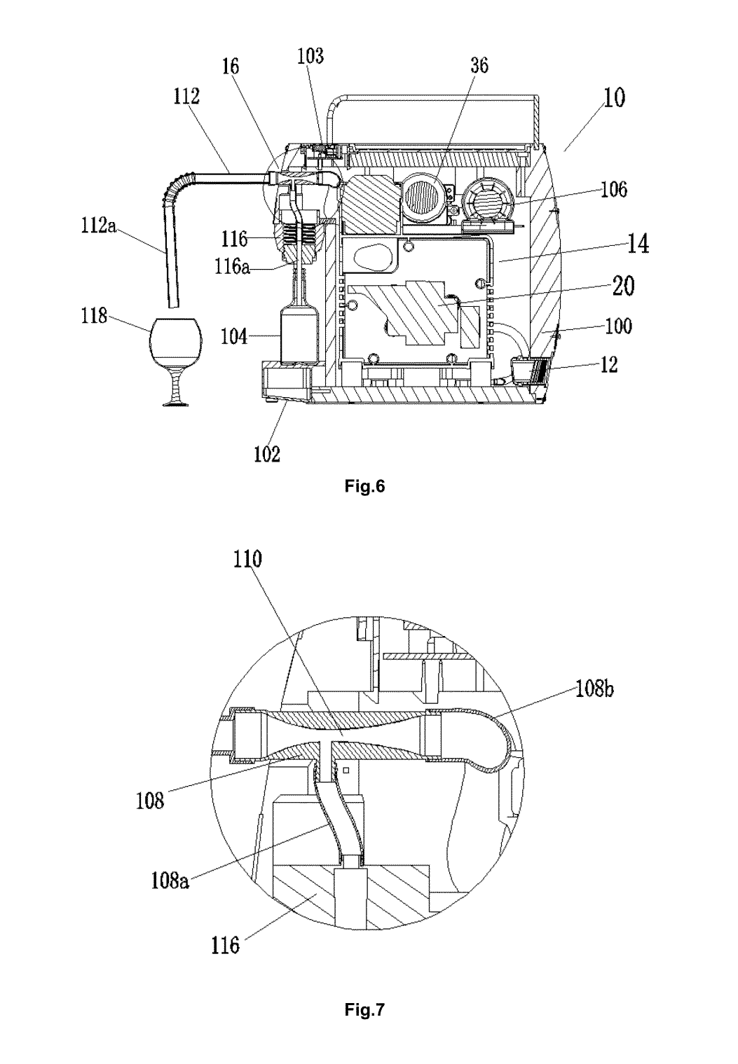

The first downwardly extending tubular part 108a of the outlet conduit 108 may be extendible to enable an end of said tubular part 108a to enter into a container 104 placed in the support plate 102 and extend downwardly into a beverage in said container 104. The first downwardly extending tubular part 108a of the outlet conduit 108 may be telescopically extensible (FIG. 4) or may be helically extensible (FIG. 6). In the embodiment of FIG. 4, the first downwardly extending tubular part 108a of the outlet conduit 108 comprises a connector 114 and first and second telescoping tubes 114a, 114b. In FIG. 6, the helically extending first downwardly extending tubular part 108a comprises a screw connector 116 and a telescopic tube 116a.

The output portion 112 of the second horizontally extending tubular part 108b extends outwardly from the housing 100 with a downturned portion 112a directing beverage into a receptacle such as a glass 118. In operation, the process of sucking a beverage such as wine from the container 104 using the pressurized flow of oxygen from the oxygen concentrator 14 causes the oxygen rich air (almost pure oxygen) to quickly aerate the wine, the process being considerably enhanced by the very high percentage of oxygen in the oxygen concentrated air.

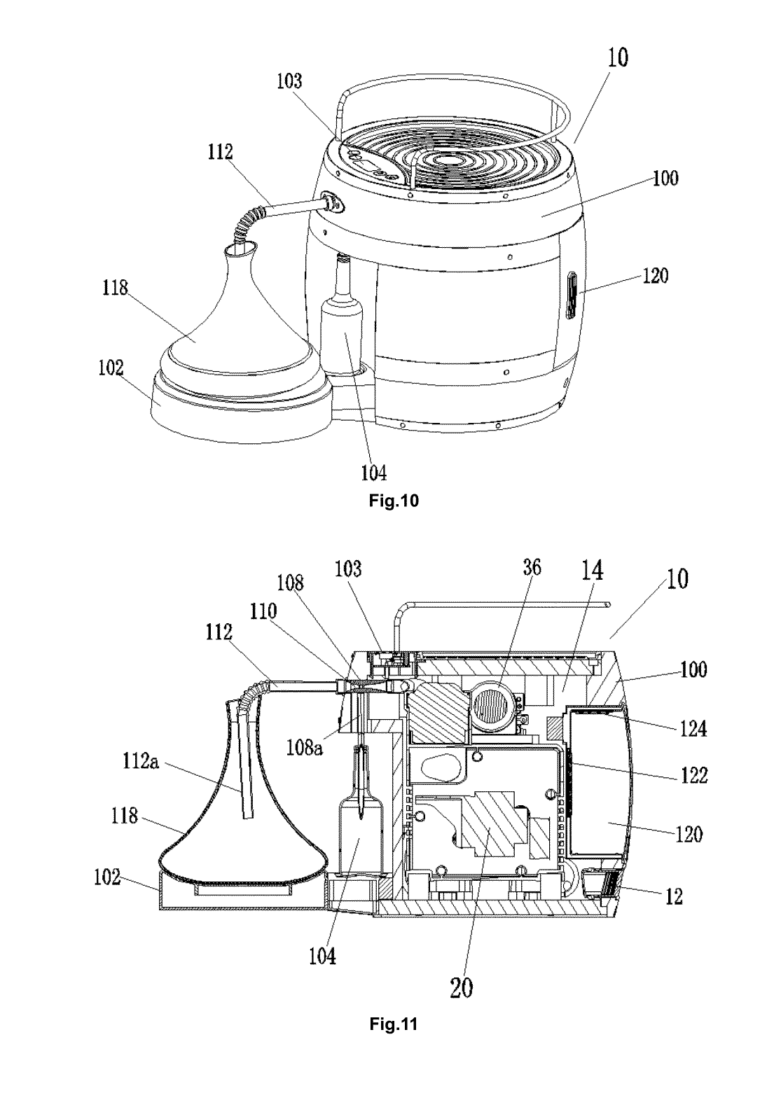

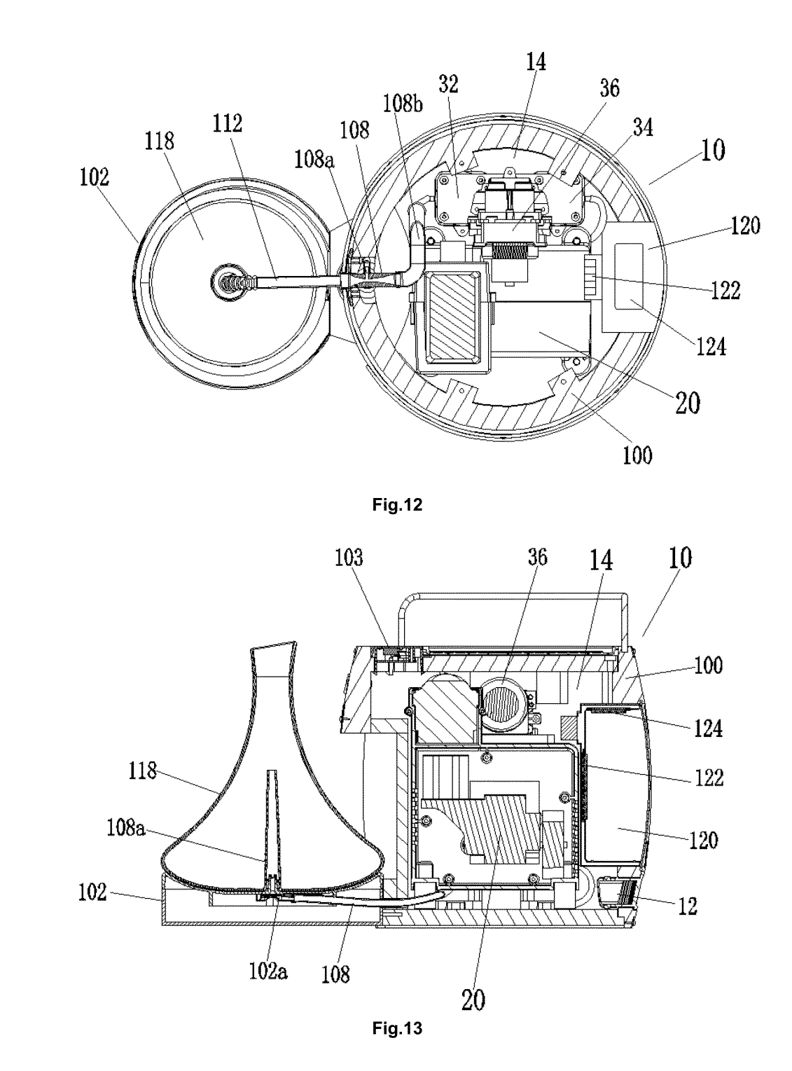

Referring now to FIGS. 10 to 15, shown is a number of further embodiments of an appliance 10 in accordance with the invention. In all of these embodiments, the appliance 10 also comprises a barrel shaped housing 100. Whist the embodiments of FIGS. 10 to 15 share many features with the embodiments of FIGS. 3 to 9, there are a number of differences. A first main difference is that, in the embodiments of FIGS. 10 to 15, the main aeration process of a beverage using oxygen concentrated air occurs in an open necked flask, decanter or jug received on an extended support plate 102 of the appliance 10.

In FIGS. 10 to 12, it can be seen that the operation of conveying wine from a bottle 104 to a receptacle 118 is largely the same as that described with respect to FIGS. 3 to 9, save for the fact that the wine or beverage is delivered to a receptacle 118 in the form of a flask and that the output portion 112 of the second horizontally extending tubular part 108b of the outlet conduit 108 extends outwardly from the housing 100 with a downturned portion 112a extending down into the receptacle 118 and into the wine contained in the receptacle 118. In operation, the process of sucking a beverage such as wine from the container 104 using the pressurized flow of oxygen from the oxygen concentrator 14 causes some oxygen rich air (almost pure oxygen) to aerate the wine as it is being conveyed to the receptacle 118, but the main aeration process continues in the receptacle 118 by virtue of the continued flow of oxygen into the beverage contained in the receptacle 118. The length of time this process continues may be under the automatic control of the controller 24 in response to user inputs at the control panel 103 and/or in response to process control data retrieved by the controller 24 from memory 28 or from a network database 54.

Another difference between the embodiments of FIGS. 10 to 15 with those of FIGS. 3 to 9 is that the former embodiments may include a beverage storage tank 120. Furthermore, a refrigeration system 122 may be provided to chill stored beverage. The refrigeration system 122 may be arranged to only chill a beverage stored in the storage tank 120. However, in addition to chilling stored beverage, or as an alternative to doing so, the refrigeration system 122 may supply cooled refrigerant to a cold plate 124 within the support plate 102 to thereby chill a beverage contained in a container or receptacle 118 received on the support plate 102.

In some embodiments, the appliance 10 may be provided with a heating system in replacement or in addition to the refrigeration system 120 for heating or warming a beverage stored in the storage tank 120. The support plate 102 may comprise a hot plate heated by said heating system to thereby heat a beverage contained in a container or receptacle 118 received on the support plate 102.

In the embodiment of FIG. 13, the outlet port conduit 108 does not extend over the support plate 102 and nor does it comprise a T shaped conduit as in other embodiments. In this embodiment, the pressurized flow of oxygen is not used to withdraw a beverage from a container or receptacle such as a bottle. The beverage is manually placed in the receptacle 118 which is then placed on the extended support plate 102. The outlet port conduit 108 comprises a single passageway which extends under the support plate 102 to a support plate outlet port 102a. The support plate outlet port 102a is adapted to sealably engage an intake port 118a of a receptacle 118 received on the support plate 102 to thereby deliver oxygen concentrated air under pressure via said receptacle intake port 118a to a beverage contained in the receptacle 118.

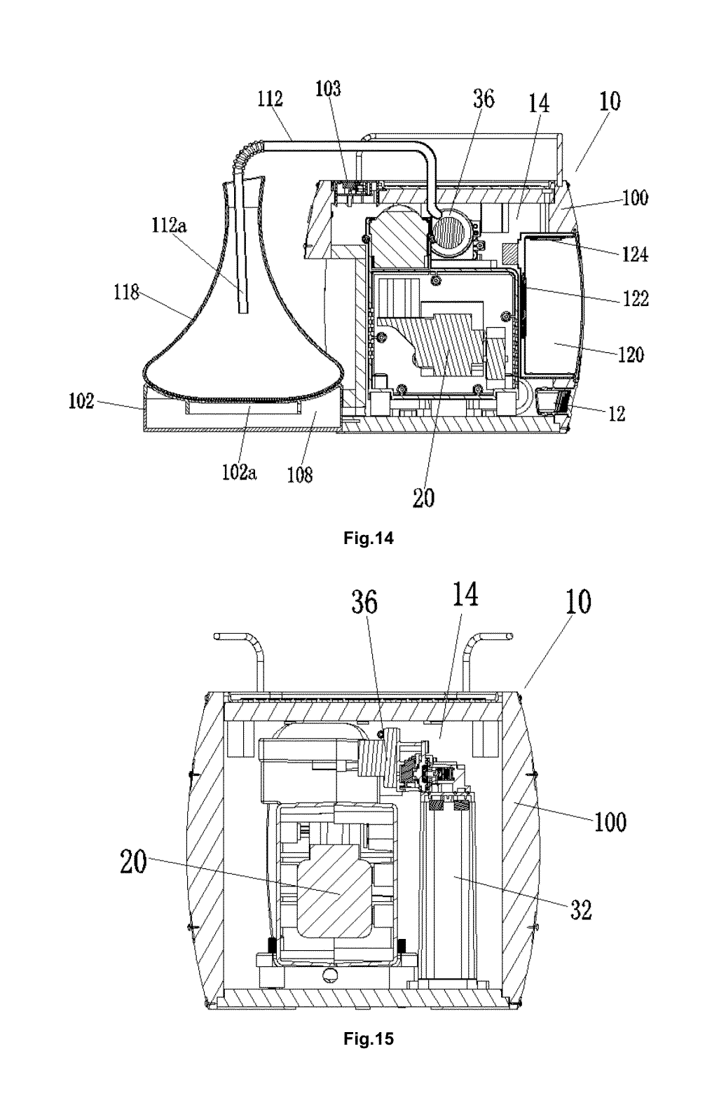

The embodiment of the appliance 10 of FIGS. 14 and 15 is similar to that of FIG. 13 in that it also does not have a suction function in its outlet port 16, but differs from the embodiment of FIG. 13 in that its outlet port conduit 108 extends over the extended support plate 102 in similar manner to other embodiments.

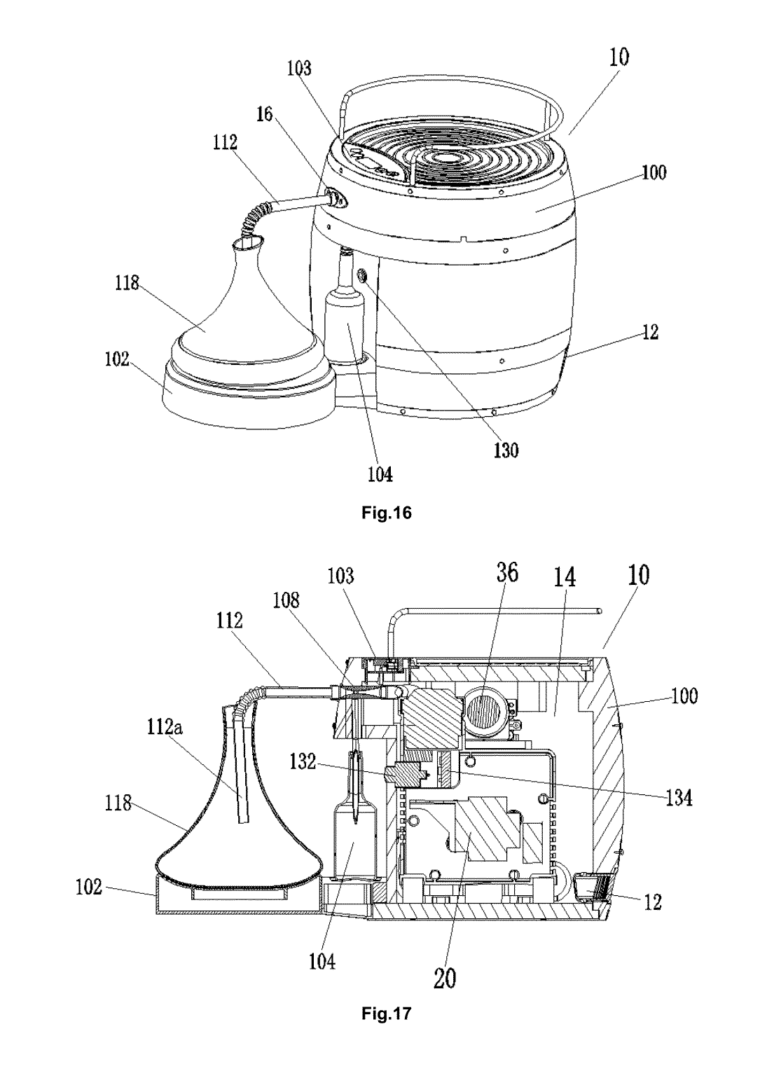

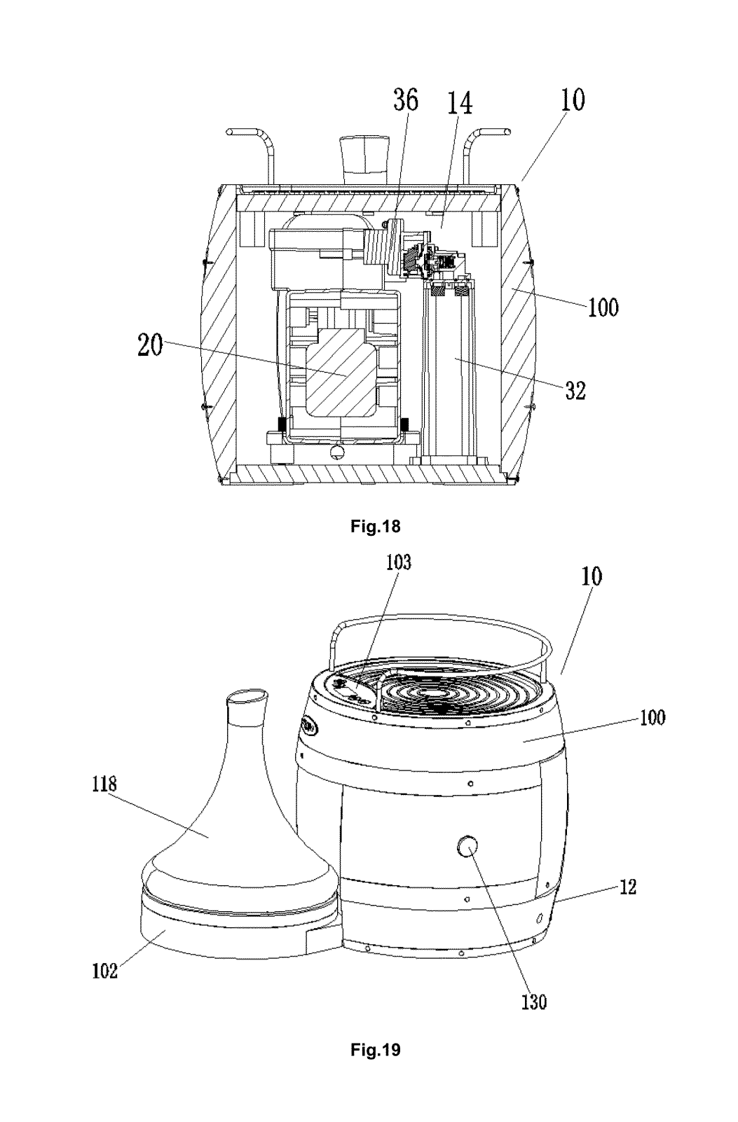

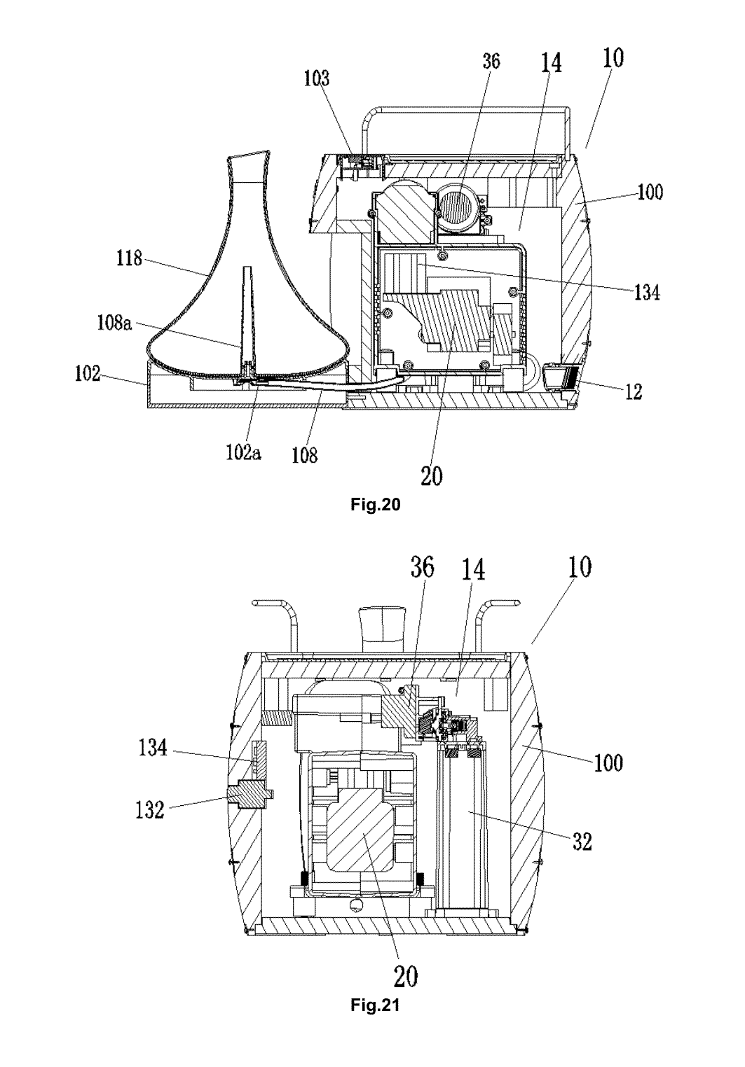

Referring to FIGS. 16 to 22, shown are yet more embodiments of the appliance 10 according to the invention. The embodiment of FIGS. 16 to 18 is largely the same as that of FIGS. 10 to 12 and the embodiment of FIGS. 19 to 21 is largely the same as that of FIGS. 13 to 15 save for the fact that the embodiments of FIGS. 16 to 21 each include a scanning system 130 adapted to automatically recognize characters, indicia, codes including bar codes and QR codes, or any other information carried on a beverage container or a label of a beverage container. The scanning system 130 may comprise an image camera 132 and an image sensor 134 under the control of the controller 24. The controller 24 executes a camera image module running recognition software or the like, although any suitable scanner such as a bar code reader may be utilized in other embodiments. The controller 24 is adapted to analyze information obtained from the scanning system 130 and to control operation of the appliance 10 in accordance with data obtained from the analyzed information. The controller 24 may determine from data obtained from the analyzed information a suitable beverage process program and control the appliance 10 to implement said program when processing a beverage from which the analyzed information was obtained. A beverage process program may include a length of time for delivery of oxygen concentrated air to said beverage, but may include other factors such as the desired temperature of the beverage, the flow rate of the oxygen concentrated air, and/or the oxygen concentration level in the oxygen concentrated air. It will be understood that oxygen concentration level in processed atmospheric air can be controlled through control of the cycle time of the pressure swing adsorption process in the oxygen concentrator apparatus As such, the appliance 10 may include a sensor for detecting a temperature of a beverage and information on detected temperature may be included in determining a suitable process program for implementation by the controller 24. In some embodiments, the detected temperature of the beverage may be used by the controller 24 to control the refrigeration system to reduce the beverage's temperature or the heating system to increase the beverage's temperature. The appliance may also include a flow meter to measure flow rates of processed air and a sensor for detecting the concentration level of oxygen in the processed air.

When scanning information associated with a beverage such as provided on a label of a wine bottle, a user may hold the bottle close to the camera and slowly rotate the bottle to enable the camera to view the whole or part of the label. The controller 24 may be arranged such that it executes software to recognize characters on the label and to interpret these. For example, recognition of the name of a wine and its year of vintage would be useful pieces of information for retrieving from memory 28 or a database 52 a set of process control steps for processing a recognized beverage. Furthermore, the controller may be adapted to recognize label symbols such as trade names or trade dress as are commonly found on wine bottle labels. Furthermore, the controller 24 may determine the quantity of beverage and adjust the process control steps accordingly, although in some embodiments the quantity of beverage may be assumed to be an amount of a standard bottle, e.g. 750 ml in the case of a bottle of wine.

The set of process control steps may comprise adjusting a time period for delivering oxygen under pressure to the wine contained in a receptacle, but could include also adjusting the temperature of the wine. An advantage of the scanning system 130 is that a user of the appliance is not required to have any experience in controlling the aeration of wine before it is consumed.

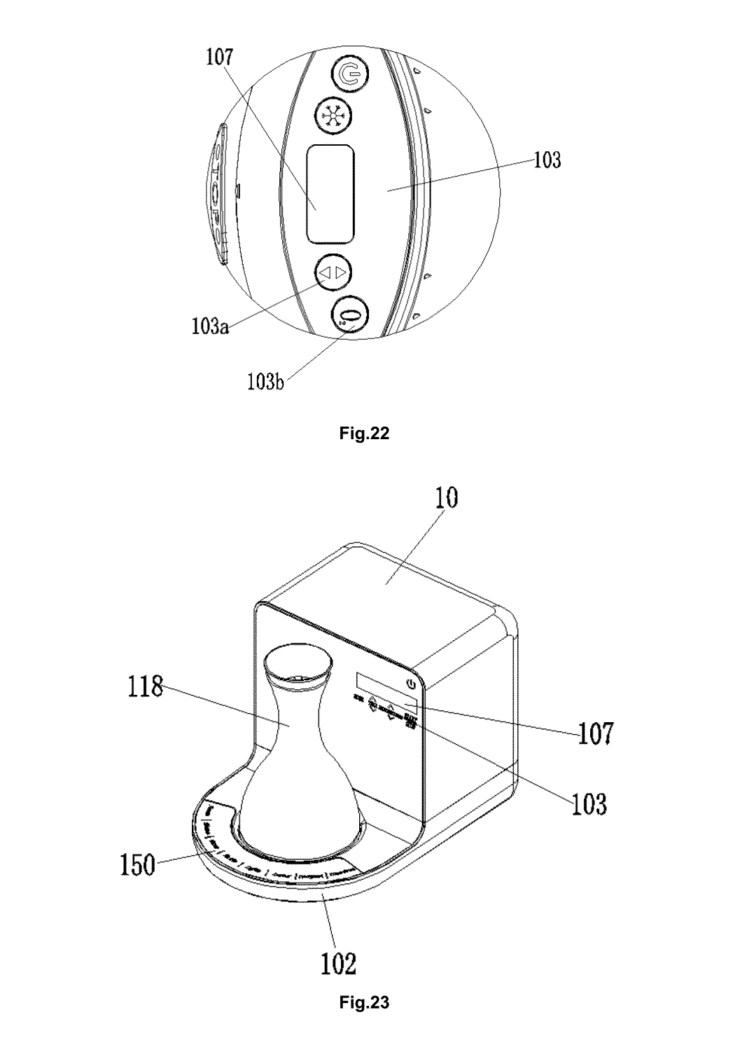

FIG. 22 shows one embodiment of a user control interface 103 for the appliance 10 in which there are provided at least one or more of a time setting button 103a and an oxygen concentration key 103b to enable a user to manually set the parameters for processing a beverage should the user wish to do so or should the scanning system fail to recognize information on the beverage container label and therefore be unable to automatically retrieve a suitable process program. The control interface 103 may include other input means and display means 107 for displaying data to a user.

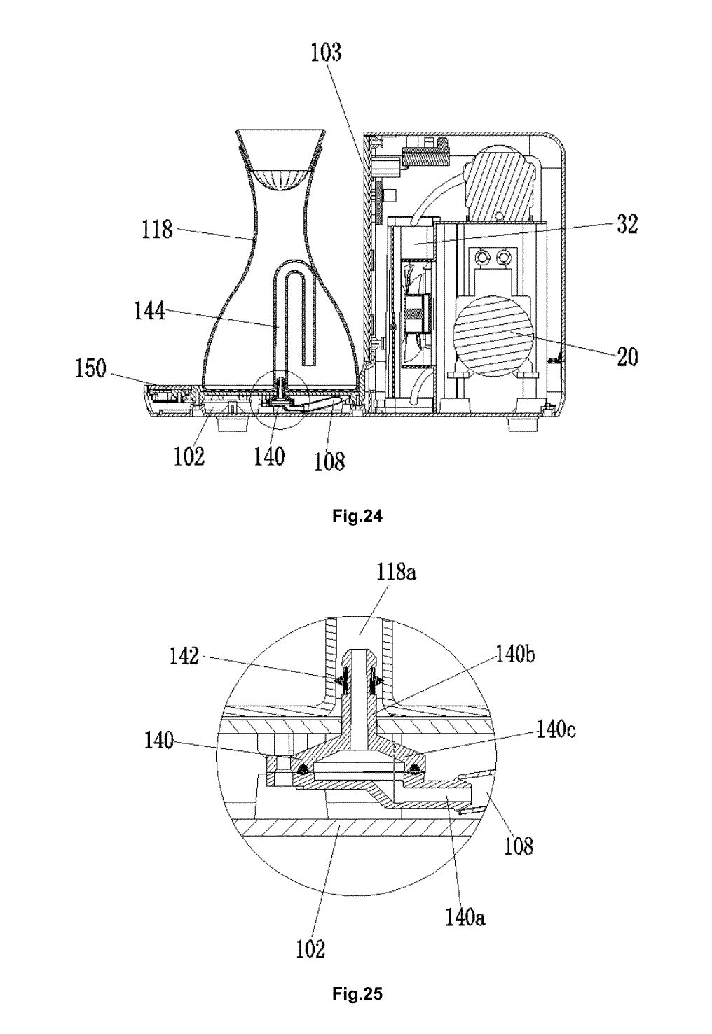

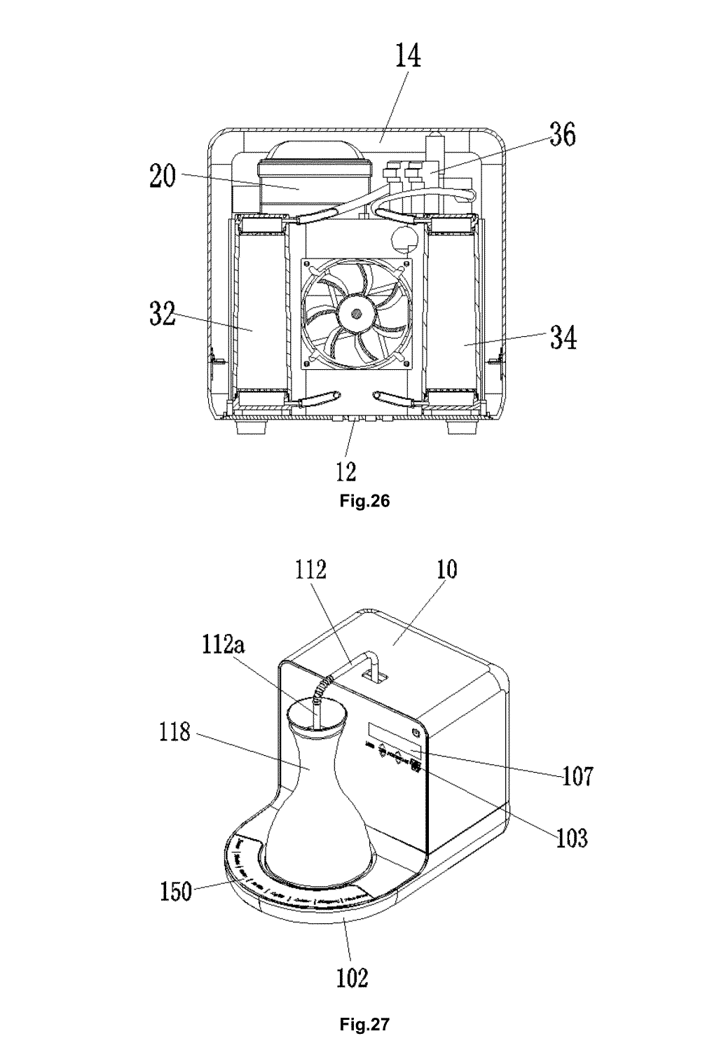

FIGS. 23 to 28 depict preferred embodiments of the invention which bring together many of the features of the already described embodiments of the appliance 10. In the embodiment of FIGS. 23 to 26 which, in FIG. 25, more clearly shows how an outlet port 102a of the support plate 102 sealably engages an inlet port 118a of a receptacle 118, it can be seen that the outlet port 102a of the support plate 102 comprises a connector 140 having an input tube 140a and an output tube 140b interconnected by a hollow base member 140c. The appliance outlet port conduit 108 sealably connects to the inlet tube 140a whilst the inlet port 118a of a receptacle 118 sealably engages the outlet tube 140b. A deformable seal 142 is provided on the outlet tube 140b to ensure a good seal is made with the inlet port 118a of the receptacle 118. The inlet port 118a of the receptacle 118 extends upwardly as an inverted tube 144 inside the receptacle 118, but it will be understood that other air lock tube systems may be used as alternatives to the inverted U shaped tube 144.

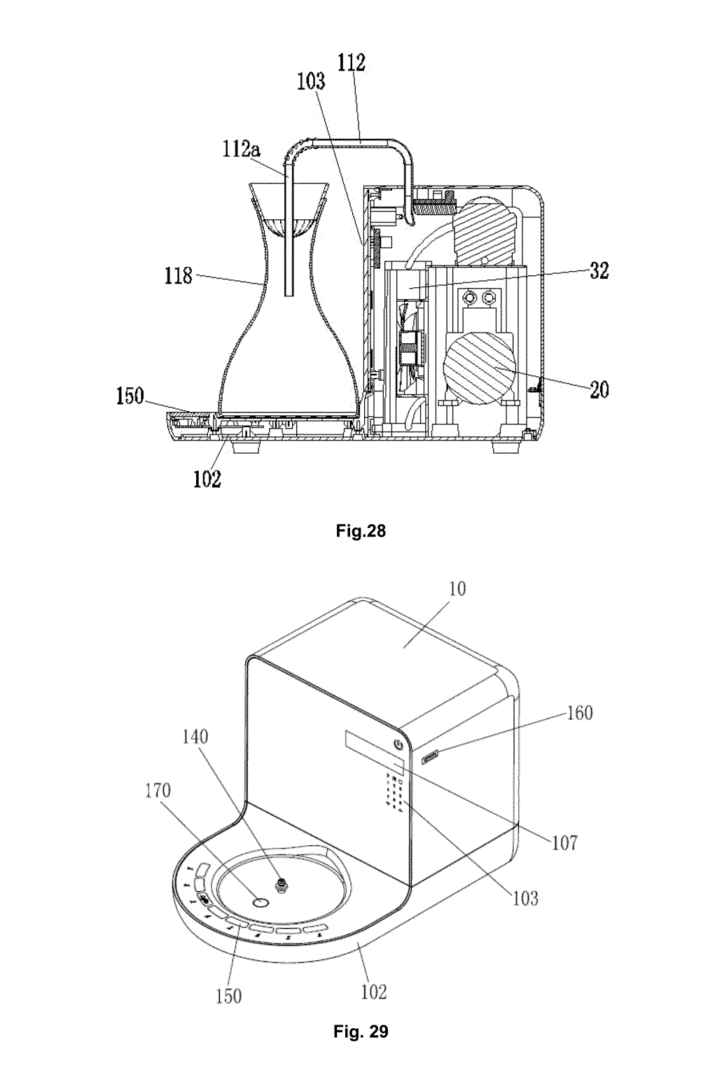

The embodiment of the appliance 10 of FIGS. 27 and 28 uses an outlet port conduit 108 which extends over the support plate 102 as in other embodiments.

The preferred embodiments of FIGS. 23 to 28 may have selection buttons 150 arranged on the support plate 102 or elsewhere on the appliance 10. The selection buttons 150 may be arranged around the periphery of the support plate 102. These buttons may be programmable soft user actuated buttons that enable a user to select a suitable process program for an identified wine by actuating a button 150 assigned to that wine (or beverage). The buttons 150 may have fixed assignments or may be programmable such that a user can program the buttons to reflect a user selection of preferred beverages for processing.

As in some other embodiments, the embodiments of the appliance 10 of FIGS. 23 to 28 include a scanning system, a communications module for wireless connection to a network, etc.

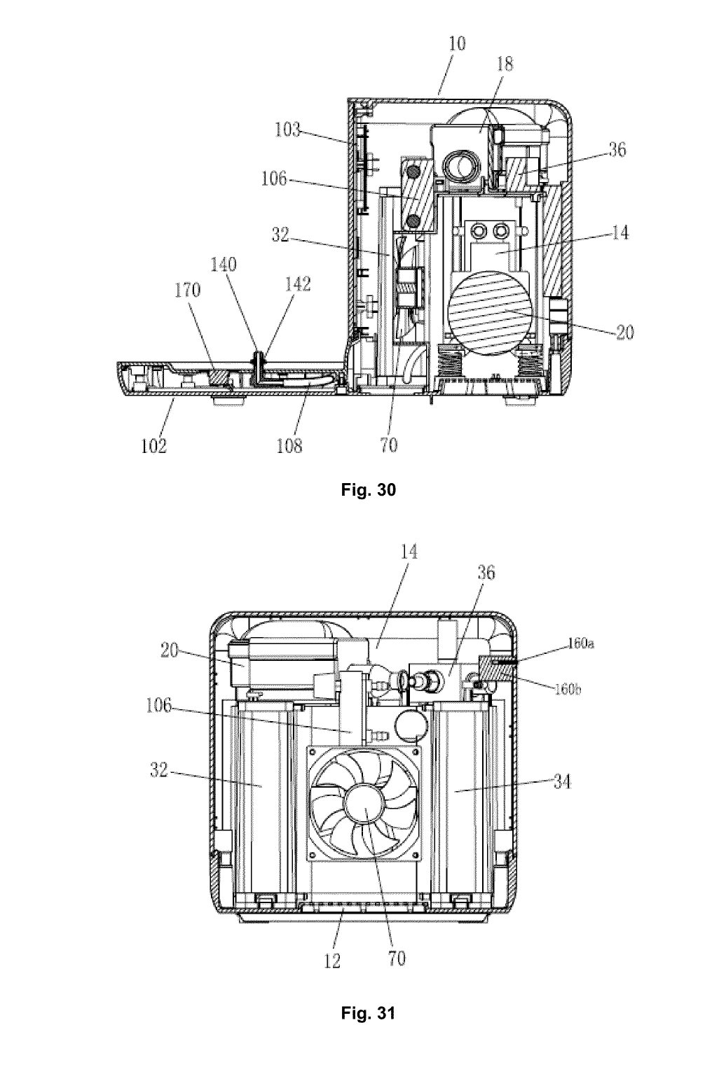

FIGS. 29 to 31 depict another preferred embodiment of the invention which embraces many of the already described aspects of the invention. In this embodiment, the support plate includes a temperature sensor 170 which detects the temperature of the beverage contained in the decanter receptacle which, in use, is received on the support plate. The detected temperature of the beverage may be utilized for setting or adjusting one or more of the parameters of a beverage process program. Additionally or alternatively, the sensed temperature may be displayed on a numerical display screen of the display means 107 of the control interface 103. The temperature sensor 170 may be arranged to determine temperature of the beverage through contact with the outside surface of the receptacle containing the beverage when said receptacle is received on the support plate or it may detect measure temperature through optical means using an infrared beam projected into the beverage.

Furthermore, the control interface 103 may be supplemented with a numerical keypad and other user input buttons to allow a user to adjust parameters of a beverage process control program according to the user's taste or experience. The adjustments may be made through incremental changes in displayed parameters using one or more of the user input buttons. The numerical keypad and other user input buttons preferably comprise a touch screen.

The numerical keypad of the control interface 103 may enable a user to input a number uniquely assigned to a specific beverage whereby the unique number identifies a beverage process control program. The program may already be downloaded to the appliance 10, but, if not, it may be downloaded in response to the entry of said unique number. Downloading of any beverage process control program may be implemented through the communications module as hereinbefore described or by way of a physical memory medium connectable to the appliance 10. One such medium comprises an SD card 160a which can be inserted into an SD card slot 160 to be read by a SD card reader 160b provided on the appliance 10. The SD card may also comprise a database of process control programs accessible by the processor of the appliance 10.

As with some other embodiments, the embodiment of FIGS. 29 to 31 carries on a peripheral edge of its support plate 102 a plurality of favorites buttons 150. These buttons may be user depressible push buttons or programmable soft user actuated buttons that enable a user to select a suitable process program for an identified wine by actuating a button 150 assigned to that wine (or beverage). The buttons 150 may have fixed assignments or may be programmable such that a user can program the buttons to reflect a user selection of preferred beverages for processing.

The apparatus described above may be implemented at least in part in software. Those skilled in the art will appreciate that the apparatus described above may be implemented at least in part using general purpose computer equipment or using bespoke equipment.

The hardware elements, operating systems and programming languages of such computers are conventional in nature, and it is presumed that those skilled in the art are adequately familiar therewith. Of course, any server functions may be implemented in a distributed fashion on a number of similar platforms, to distribute the processing load.

Program aspects of the technology can be thought of as “products” or “articles of manufacture” typically in the form of executable code and/or associated data that is carried on or embodied in a type of machine readable medium. “Storage” type media include any or all of the memory of computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. An electrical appliance for processing a beverage, said electrical appliance comprising:
an inlet for drawing in atmospheric air;
an air processing apparatus for concentrating oxygen in the drawn in air;
an outlet for delivering oxygen concentrated air under pressure to a beverage.

2. The electrical appliance of claim 1, wherein the outlet of the appliance comprises a conduit which extends to a support plate to deliver oxygen concentrated air under pressure to a beverage contained in a container or receptacle received on the support plate.

3. The electrical appliance of claim 2, wherein the conduit extends under the support plate to a support plate outlet port, the support plate outlet port being adapted to sealably engage an intake port of a container received on the support plate to thereby deliver oxygen concentrated air under pressure via said container intake port to a beverage contained in the container.

4. The electrical appliance of claim 1, wherein the air processing apparatus comprises an oxygen concentrator apparatus adapted to remove some or most gases other than oxygen from atmospheric air to thereby provide oxygen concentrated air.

5. The electrical appliance of claim 4, wherein the oxygen concentrator apparatus comprises a molecular sieve adapted to remove some or most gases other than oxygen from atmospheric air to thereby provide oxygen concentrated air.

6. The electrical appliance of claim 4, wherein the oxygen concentrator apparatus is operated to provide oxygen concentrated air having an adjustable percentage of oxygen by volume of at least 30%.

7. The electrical appliance of claim 1, wherein the appliance has a scanning system adapted to automatically recognize characters, indicia, codes including bar codes and QR codes, or any other information carried on a beverage container or a label of a beverage container.

8. The electrical appliance of claim 7, wherein a computer implemented controller of the appliance is adapted to analyze information obtained from the scanning system and to control operation of the appliance in accordance with data obtained from the analyzed information.

9. The electrical appliance of claim 8, wherein the controller determines from data obtained from the analyzed information a suitable beverage process program and controls the appliance to implement said program when processing a beverage from which the analyzed information was obtained.

10. A method of processing a beverage; the method comprising the step of:
automatically passing oxygen concentrated air under pressure through the beverage for a predetermined period of time.

11. An electrical appliance comprising:
an outlet for delivering oxygen under pressure to a beverage;
a controller for automatically controlling the delivery of oxygen to said beverage; and
a communications module for connecting to a communications network to download data from a computer system.

12. An electrical appliance comprising:
an outlet for delivering oxygen under pressure to a beverage;
a controller for automatically controlling the delivery of oxygen to said beverage; and
a scanning system adapted to automatically recognize characters, indicia, codes including bar codes and QR codes, or any other information carried on a beverage container or a label of a beverage container.

13. An electrical appliance comprising:
an outlet for delivering oxygen under pressure to a beverage;
a controller for automatically controlling the delivery of oxygen to said beverage; and
a temperature sensor for determining a temperature of a beverage being processed.

14. The electrical appliance of claim 11, wherein the oxygen delivered to the beverage comprises unprocessed atmospheric air, already prepared pure or near pure oxygen, or oxygen concentrated air obtained from atmospheric air by the appliance.

15. A computer program product comprising machine readable instructions which when executed by a controller of an electrical appliance causes said electrical appliance to automatically pass oxygen under pressure through a beverage for a predetermined period of time.
